(19) United States
(12) Patent Application Publication
(10) Pub. No.: US 2011/0158155 A1
(43) Pub. Date: Jun. 30, 2011

(54) APPARATUS AND METHOD FOR MANAGING QUALITY OF SERVICE IN BROADBAND WIRELESS COMMUNICATION SYSTEM WITH MULTIPLE HOP RELAY COMMUNICATION

(75) Inventors: Jung Shin PARK, Seoul (KR); Hyun-Jeong KANG, Seoul (KR); Rakesh TAORI, Suwon-si (KR)

(73) Assignee: SAMSUNG ELECTRONICS CO. LTD., Suwon-si (KR)

(21) Appl. No.: 12/976,221

(22) Filed: Dec. 22, 2010

(30) Foreign Application Priority Data
Dec. 30, 2009 (KR) 10-2009-0134179

(51) Int. Cl. H04W 40/22

(52) U.S. Cl. 370/315

(57) ABSTRACT

A Relay Station (RS) apparatus and an operation method for managing a Quality of Service (QoS) in a broadband wireless communication system with multi-hop relay communication are provided. The operation method of the RS includes, if generation of a service flow is requested from a Portable Subscriber Station (PSS) accessing the RS, allocating a first downlink IDentifier (ID) corresponding to the service flow to a first tunnel between a Base Station (BS) and the RS, transmitting the first downlink ID to the BS and requesting the BS to establish a second tunnel between the BS and an Access Control Router (ACR) for the service flow, receiving a response to the request of establishing the second tunnel and a first uplink ID corresponding to the service flow and allocated to the first tunnel, and storing the first uplink ID.

### PRIORITY

This application claims the benefit under 35 U.S.C. §119(a) of a Korean patent application filed in the Korean Intellectual Property Office on Dec. 30, 2009 and assigned Serial No. 10-2009-0134179, the entire disclosure of which is hereby incorporated by reference.

### BACKGROUND OF THE INVENTION

1. Field of the Invention

The present invention relates to a broadband wireless communication system. More particularly, the present invention relates to an apparatus and a method for managing Quality of Service (QoS) by a Portable Subscriber Station (PSS) in a broadband wireless communication system with multi-hop relay communication.

2. Description of the Related Art

In a 4^{th} Generation (4G) communication system, which is the next generation communication system, intensive research is being conducted to provide users with services of various Quality of Services (QoSs) at a data rate of about 100 Megabits per second (Mbps). More particularly, a study of the 4 G communication system is now made to support high-speed services by guaranteeing mobility and QoS for a Broadband Wireless Access (BWA) communication system, such as a wireless Local Area Network (LAN) system and a wireless Metropolitan Area Network (MAN) system. The typical 4 G communication system is an Institute of Electrical and Electronics Engineers (IEEE) 802.16 communication system. The IEEE 802.16 communication system employs an Orthogonal Frequency Division Multiplexing/Orthogonal Frequency Division Multiple Access (OFDM/OFDMA) scheme in a physical channel in order to support a broadband transmission network.

In the IEEE 802.16 communication system, active research has been conducted to secure the mobility of a Portable Subscriber Station (PSS) and the flexibility of wireless network configuration and to provide a more efficient service in a wireless environment experiencing fluctuating changes in traffic distribution or the number of required calls. One method of providing a more efficient service is the consideration of a communication system employing a data transmission scheme of a multi-hop relay form using a Relay Station (RS). By using the RS, the broadband wireless communication system increases the coverage of a Base Station (BS), improves a throughput, and the like. That is, the broadband wireless communication system can provide services such that a PSS can communicate with the BS out of the coverage of the BS, by locating an RS in a specific area of a poor channel environment or near a cell boundary.

To apply a multi-hop relay technique that provides an increased coverage, an improved throughput, and the like, a system has to provide additional functions. For example, the system requires a scheduling technique of a BS for controlling an operation of an RS, a scheduling technique for guaranteeing resource use of the RS, a function for setting a link between the RS and a PSS, a link between the RS and the BS, and the like. Accordingly, in a case where the system intends to apply the multi-hop relay technique, the system cannot utilize the existing equipment designed for single hop communication including the existing BS. In addition, research has been conducted on methods for providing relay services without changing the existing equipment designed for single hop communication, such as a BS, an Access Service Network (ASN) server, or the like. However, these methods are not capable of guaranteeing the QoS of a PSS.

Therefore, a need exists for an apparatus and a method for supporting a multi-hop relay technique that guarantees the QoS of a PSS by the minimum change in a broadband wireless communication system.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for supporting a multi-hop relay technique that guarantees a Quality of Service (QoS) of a Portable Subscriber Station (PSS) by the minimum change in a broadband wireless communication system.

Another aspect of the present invention is to provide an apparatus and a method for, at multi-hop relay communication, establishing data paths corresponding to service flows of a PSS on a point-to-point basis between a Base Station (BS) and an Access Control Router (ACR) in a broadband wireless communication system.

A further aspect of the present invention is to provide an apparatus and a method for, at multi-hop relay communication, establishing one data path between a BS and a Relay Station (RS) and forwarding a plurality of service flows through the one data path in a broadband wireless communication system.

Still another aspect of the present invention is to provide an apparatus and a method for, at multi-hop relay communication, determining a service flow of a PSS corresponding to data forwarded through one data path between an RS and a BS in a broadband wireless communication system.

In accordance with an aspect of the present invention, an operation method of an RS in a broadband wireless communication system with multi-hop relay communication is provided. The operation method includes, if generation of a service flow is requested from a PSS accessing the RS, allocating a first downlink IDentifier (ID) corresponding to the service flow to a first tunnel between a BS and the RS, transmitting the first downlink ID to the BS and requesting the BS to establish a second tunnel between the BS and an ACR for the service flow, receiving a response to the request of establishing the second tunnel and a first uplink ID corresponding to the service flow and allocated to the first tunnel, and storing the first uplink ID.

In accordance with another aspect of the present invention, an operation method of a BS in a broadband wireless communication system with multi-hop relay communication is provided. The method includes receiving, from an RS, a request for establishment of a second tunnel between the BS and an ACR for a service flow of a PSS and a first downlink ID corresponding to the service flow and allocated to a first tunnel between the RS and the BS, allocating a second downlink ID corresponding to the service flow to the second tunnel, transmitting the second tunnel establishment request and the second downlink ID to the ACR, receiving a response to the second tunnel establishment request and allocating a second uplink ID corresponding to the service flow to the second tunnel, establishing a data path for the service flow between the ACR and the BS, allocating a first uplink ID corresponding to the service flow to the first tunnel, and transmitting the response to the second tunnel establishment request of the RS and the first uplink ID.

In accordance with a further aspect of the present invention, an operation method of an ACR in a broadband wireless communication system with multi-hop relay communication is provided. The method includes receiving, from a BS, a request for establishment of a second tunnel between the BS and the ACR for a service flow of a PSS and a second downlink ID corresponding to the service flow and allocated to the second tunnel, allocating a second uplink ID to the second tunnel, transmitting a response to the second tunnel establishment request and the second uplink ID, to the BS, and establishing the data path for the service flow between the ACR and the BS.

In accordance with a further aspect of the present invention, an RS apparatus in a broadband wireless communication system with multi-hop relay communication is provided. The apparatus includes a controller and a modem. If generation of a service flow is requested from a PSS accessing the RS, the controller allocates a first downlink ID corresponding to the service flow to a first tunnel between a BS and the RS. The modem transmits the first downlink ID to the BS and simultaneously, transmits a message to the BS requesting establishment of a second tunnel between the BS and an ACR for the service flow, and receives a response to the request of establishing the second tunnel and a first uplink ID corresponding to the service flow and allocated to the first tunnel. The controller stores the first uplink ID.

In accordance with a further aspect of the present invention, a BS apparatus in a broadband wireless communication system with multi-hop relay communication is provided. The apparatus includes a controller and a modem. If a request for establishment of a second tunnel between the BS and an ACR for a service flow of a PSS and a first downlink ID corresponding to the service flow and allocated to a first tunnel between an RS and the BS are received from the RS, the controller allocates a second downlink ID corresponding to the service flow to the second tunnel. The modem transmits the second tunnel establishment request and allocation of the second downlink ID to the ACR. If a response to the second tunnel establishment request and a second uplink ID corresponding to the service flow and allocated to the second tunnel are received, the controller establishes a data path for the service flow between the ACR and the BS, and allocates a first uplink ID corresponding to the service flow to the first tunnel. The modem transmits the response to the second tunnel establishment request of the RS and the first uplink ID.

In accordance with a further aspect of the present invention, an ACR apparatus in a broadband wireless communication system with multi-hop relay communication is provided. The apparatus includes a controller and a modem. If a request for establishment of a second tunnel between a BS and the ACR for a service flow of a PSS and a second downlink ID corresponding to the service flow and allocated to the second tunnel are received from the BS, the controller allocates a second uplink ID to the second tunnel. The modem transmits a response to the second tunnel establishment request and allocation of the second uplink ID, to the BS. The controller establishes the data path for the service flow between the ACR and the BS.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a diagram illustrating a schematic link configuration at single hop communication in a broadband wireless communication system according to an exemplary embodiment of the present invention;

FIG. 2 is a diagram illustrating a signal exchange for a service flow at single hop communication in a broadband wireless communication system according to an exemplary embodiment of the present invention;

FIG. 3 is a diagram illustrating a schematic link configuration at multi-hop relay communication in a broadband wireless communication system according to an exemplary embodiment of the present invention;

FIGS. 4A and 4B are diagrams illustrating packet structures at multi-hop relay communication in a broadband wireless communication system according to an exemplary embodiment of the present invention;

FIG. 5 is a diagram illustrating a signal exchange for a service flow at multi-hop relay communication in a broadband wireless communication system according to an exemplary embodiment of the present invention;

FIG. 6 is a diagram illustrating a signal exchange for Quality of Service (QoS) update of a service flow between a Relay Station (RS) and a Base Station (BS) at multi-hop relay communication in a broadband wireless communication system according to an exemplary embodiment of the present invention;

FIG. 7 is a flowchart illustrating an operation procedure of an RS in a broadband wireless communication system according to an exemplary embodiment of the present invention;

FIG. 8 is a flowchart illustrating an operation procedure of a BS in a broadband wireless communication system according to an exemplary embodiment of the present invention;

FIG. 9 is a flowchart illustrating an operation procedure of an Access Control Router (ACR) in a broadband wireless communication system according to an exemplary embodiment of the present invention;

FIG. 10 is a block diagram illustrating a construction of an RS in a broadband wireless communication system according to an exemplary embodiment of the present invention;

FIG. 11 is a block diagram illustrating a construction of a BS in a broadband wireless communication system according to an exemplary embodiment of the present invention; and

FIG. 12 is a block diagram illustrating a construction of an ACR in a broadband wireless communication system according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention are provided for purposes of illustration only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

The following description is made for a technology for supporting a multi-hop relay technique that guarantees a Quality of Service (QoS) of a Portable Subscriber Station (PSS) by the minimum change in a broadband wireless communication system. The following description is made, for example, for an Orthogonal Frequency Division Multiplexing/Orthogonal Frequency Division Multiple Access (OFDM/OFDMA) wireless communication system, but is applicable to other wireless communication systems as well.

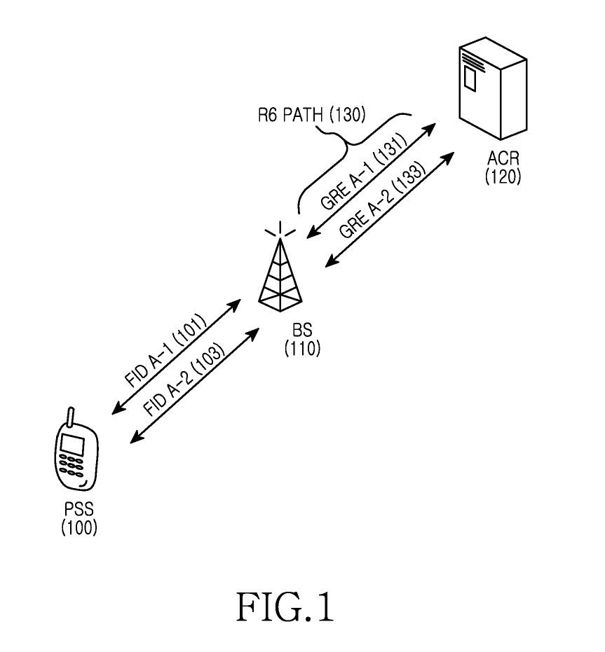

FIGS. 1 through 12, discussed below, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly state otherwise. A set is defined as a non-empty set including at least one element.

FIG. 1 is a diagram illustrating a schematic link configuration at single hop communication in a broadband wireless communication system according to an exemplary embodiment of the present invention.

Referring to FIG. 1, a system including a PSS 100, a Base Station (BS) 110, and an Access Control Router (ACR) 120 is illustrated. The PSS 100 is a user equipment and accesses the BS 110 through a wireless channel. The BS 110 manages the mobility of the PSS 100 and resource allocation, and supports a wireless communication for the PSS 100. The BS 110 may be referred to as a Radio Access Station (RAS). The ACR 120 is an entity for the role of a gateway for connection with a backbone network and the control of the BS 110, and is also called an Access Service Network-GateWay (ASN-GW). An R6 path 130 is established between the BS 110 and the ACR 120 for the sake of PSSs provided with wireless communication services through the BS 110. The R6 path 130 corresponds to a Generic Routing Encapsulation (GRE) tunnel carrying data of the PSSs.

Here, the R6 is a control plane and bearer plane protocol for communication between the BS 110 and the ACR 120. The control plane includes a protocol for data path establishment, modification, and release control according to the mobility event of the PSS 100, and the bearer plane includes a protocol for an intra-ASN data path between the BS 110 and the ACR 120.

In FIG. 1, the PSS 100 holds two service flows (i.e., a Flow IDentifier (FID) A-1 101 and an FID A-2 103). The FID A-1 101 and the FID A-2 103 are mapped to GRE tunnels (i.e., a GRE A-1 131 and a GRE A-2 133) established within the R6 path 130, respectively. That is, as many GRE tunnels as the number of service flows generated between the BS 110 and the PSS 100 are generated between the ACR 120 and the BS 110.

The GRE A-1 131 and the GRE A-2 133 are GRE tunnels for transmitting data of the PSS 100. GRE tunnel IDs are selected one by one per one GRE tunnel in a GRE tunnel ID pool of each of the BS 110 and the ACR 120. That is, the BS 110 selects a GRE tunnel ID 1 to be transmitted to the ACR 120 for the GRE A-1 131, and the ACR 120 selects a GRE tunnel ID 2 to be transmitted to the BS 110 for the GRE A-1 131. Furthermore, after the BS 110 and the ACR 120 exchange the GRE tunnel ID information with each other, the BS 110 and the ACR 120 maintain each mapping information on the GRE tunnel ID 1 and the GRE tunnel ID 2. For description convenience below, exemplary embodiments of the present invention call the GRE tunnel ID selected in the GRE tunnel ID pool of the BS 110, a ‘BS GRE tunnel ID’, and the GRE tunnel ID selected in the GRE tunnel ID pool of the ACR 120, an ‘ACR GRE tunnel ID’.

An example of data forwarding dependent on a corresponding relationship between a service flow and a GRE tunnel is described below. If DownLink (DL) data of the PSS 100 for the service flow (i.e., the FID A-1 101) reaches the ACR 120, the ACR 120 forwards the DL data of the PSS 100 to the BS 110 through the GRE A-1 131. Moreover, the BS 110 forwards the DL data to the PSS 100 through the FID A-1 101.

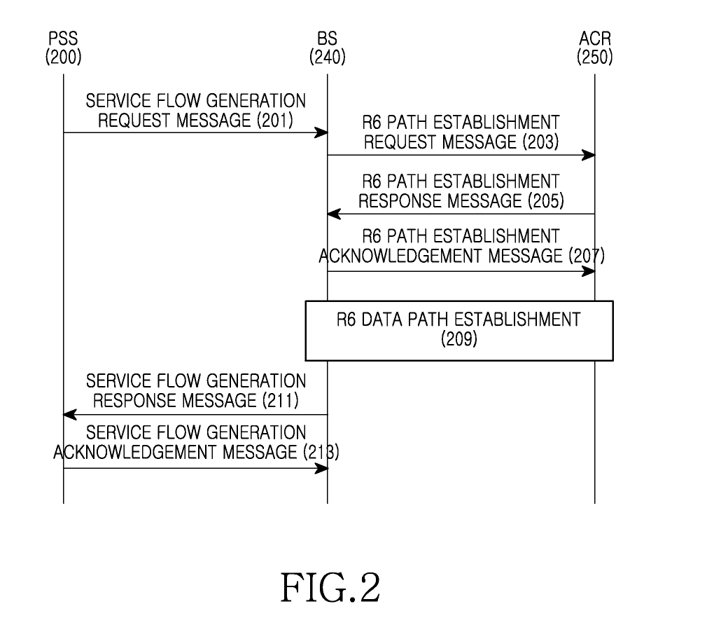

FIG. 2 is a diagram illustrating a signal exchange for a service flow at single hop communication in a broadband wireless communication system according to an exemplary embodiment of the present invention.

Referring to FIG. 2, in step 201, a PSS 200 transmits a service flow generation request message (Dynamic Service Addition-REQuest (DSA-REQ)) to a BS 240 to set a new service flow. The service flow generation request message (DSA-REQ) includes QoS characteristic information of a service flow that the PSS 200 intends to generate, and the like. At this time, although no illustration is given, the BS 240 can transmit to the PSS 200 a service flow generation reception acknowledgement message (Dynamic Service Addition-ReCeiVe (DSA-RCV)) informing the PSS 200 that it has received the service flow generation request message (DSA-REQ) from the PSS 200.

In step 203, the BS 240 receiving the service flow generation request message (DSA-REQ) transmits a data path establishment request message (R6-PATH-REGistration-REQuest (R6-PATH-REG-REQ)) to ACR 250 so as to establish a GRE tunnel corresponding to the service flow requested by the PSS 200. The data path establishment request message (R6-PATH-REG-REQ) includes service flow request information of the PSS 200, BS GRE tunnel ID information of the GRE tunnel mapped with the service flow, and the like. Here, the GRE tunnel ID denotes a GRE tunnel key, and is called a ‘GRE tunnel ID’ in exemplary embodiments of the present invention.

Thereafter, the ACR 250 receiving the data path establishment request message (R6-PATH-REG-REQ) processes the service flow request information of the PSS 200. In step 205, the ACR 250 transmits a data path establishment response message (R6-PATH-REGistration-ReSPonse (R6-PATH-REG-RSP)) to the BS 240. The data path establishment response message (R6-PATH-REG-RSP) includes ID information on the service flow of the PSS 200, QoS characteristic information of the service flow, ACR GRE tunnel ID information of the GRE tunnel mapped with the service flow, and the like.

In step 207, the BS 240 receiving the data path establishment response message (R6-PATH-REG-RSP) transmits a data path establishment acknowledgement message (R6-PATH-REGistration-ACKnowledge (R6-PATH-REG-ACK)) to the ACR 250. In step 209, the BS 240 and the ACR 250 establish an R6 path (i.e., a GRE tunnel) to process data of the PSS 200. At this time, regarding the R6 path, the BS 240 and the ACR 250 manage mapping information on the BS GRE tunnel ID and the ACR GRE tunnel ID included in the data path establishment request message (R6-PATH-REG-REQ) and the data path establishment response message (R6-PATH-REG-RSP), respectively. In a case of transmitting the data of the PSS 200 through the R6 path, the BS 240 and the ACR 250 set the BS GRE tunnel ID and the ACR GRE tunnel ID for transmission.

Thereafter, in step 211, the BS 240 transmits a service flow generation response message (Dynamic Service Addition-ReSPonse (DSA-RSP)) to the PSS 200. The service flow generation response message (DSA-RSP) includes an ID of a service flow requested by the PSS 200, a flow ID for identifying the service flow between the BS 240 and the PSS 200, QoS characteristic information of the service flow, and the like.

Next, in step 213, the PSS 200 transmits a service flow generation acknowledgement message (Dynamic Service Addition-ACKnowledge (DSA-ACK)) to the BS 240.

A description of the signal exchange process of FIG. 2 applied to the structure of FIG. 1 is made below. The GRE A-1 131 for carrying data of the PSS 100 between the BS 110 and the ACR 120 is generated through step 209, and the FID A-1 101 between the PSS 100 and the BS 110 is generated through step 213.

As illustrated in FIGS. 1 and 2, the broadband wireless communication system supports single hop communication. Together with this, the broadband wireless communication system supports multi-hop relay communication. At this time, the multi-hop relay communication supported in the broadband wireless communication system has the following characteristics.

The first is that Layer2 (L2), i.e., Media Access Control (MAC), signaling from a PSS is processed by an RS. For example, the RS manages a STation IDentifier (STID) of the PSS. Accordingly, the RS generates an R6 signaling message for the sake of processing of a control message of the PSS, and a BS relays the R6 signaling message generated in the RS, to an ACR.

The second is that data transmission of a PSS is addressed through an R8 GRE tunnel in a link between an RS and a BS, and through an R6 GRE tunnel in a link between the BS and an ACR. The number of the R6 GRE tunnels is the same as the number of service flows between the RS and the PSS, but the R8 GRE tunnel is one irrespective of the number of the service flows between the RS and the PSS. Although the R8 GRE tunnel is one in number, two or more service flows between the RS and the BS can be set and managed. In this case, R8 GRE tunnel ID information mapped to each of the service flows between the RS and the BS should be managed separately.

Here, the R8, a protocol devised for communication between BSs, includes a control plane message flow and a bearer plane data flow. The bearer plane includes a protocol for data forwarding between the BSs, and the control plane includes a protocol controlling the data forwarding between the BSs.

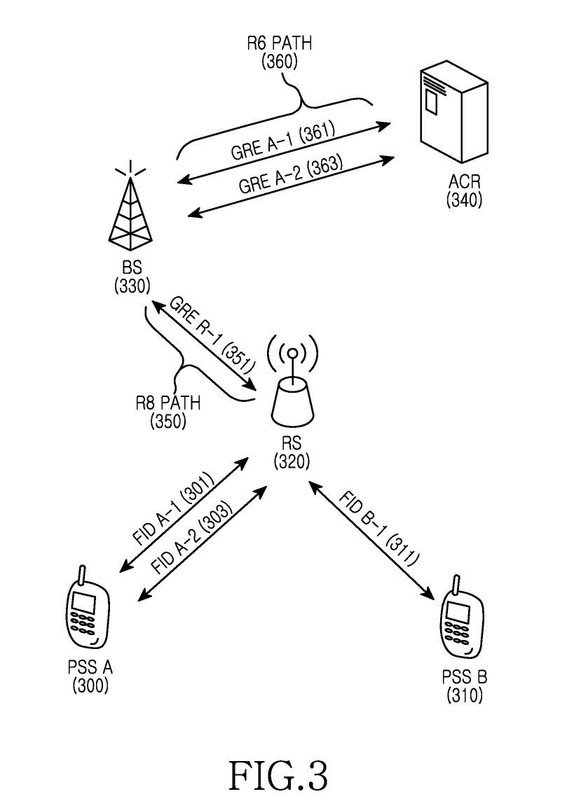

FIG. 3 is a diagram illustrating a schematic link configuration at multi-hop relay communication in a broadband wireless communication system according to an exemplary embodiment of the present invention.

Referring to FIG. 3, a system for multi-hop relay communication including a PSS A 300, a PSS B 310, an RS 320, a BS 330, and an ACR 340 is illustrated. The PSS A 300 and the PSS B 310 are user equipments and access the RS 320 or the BS 330 through a wireless channel. The RS 320 is an entity for multi-hop communication. The RS 320 operates like the PSS A 300 and the PSS B 310 from the point of view of the BS 330, and operates like the BS 330 from the points of view of the PSS A 300 and the PSS B 310. The BS 330 supports wireless communication to the RS 320, the PSS A 300, and the PSS B 310. The ACR 340 is an entity for the role of a gateway for connection with a backbone network and the control of the BS 330, and corresponds to an ASN-GW.

In a case of the relay communication, although the BS 330 manages the RS 320 like one PSS, the BS 330 recognizes the RS 320 as a relay system, and recognizes the existence of the PSS A 300 and the PSS B 310 accessing the RS 320. Although the PSS A 300 and the PSS B 310 accessing the RS 320 recognize the RS 320 as the relay system, the PSS A 300 and the PSS B 310 perform communication with the RS 320 in the same manner as single hop communication with the BS 330. An R6 path 360 is established between the BS 330 and the ACR 340 for the sake of PSSs provided with wireless communication services through the BS 330. The R6 path 360 corresponds to a GRE tunnel carrying data of the PSSs.

The PSS A 300 holds two service flows (i.e., an FID A-1 301 and an FID A-2 303). The FID A-1 301 and the FID A-2 303 are mapped to a GRE A-1 361 and a GRE A-2 363 established within the R6 path 360, respectively. That is, as many GRE tunnels as the number of service flows generated between the RS 320 and the PSSs 300 and 310 are generated between the ACR 340 and the BS 330.

An R8 path 350 is established between the RS 320 and the BS 330 for the PSSs 300 and 310 provided with relay communication services through the RS 320. The R8 path 350 corresponds to a GRE tunnel carrying data of the PSSs connected to the RS 320. A GRE tunnel (GRE R-1) 351 is established within the R8 path 350. The GRE R-1 351 is used to forward data for the service flow (FID A-1) 301 and the service flow (FID A-2) 303 of the PSS A 300 accessing the RS 320, and a service flow (FID B-1) 311 of the PSS B 310. That is, the GRE tunnel between the BS 330 and the RS 320 is one irrespective of the number of service flows generated between the RS 320 and the PSSs 300 and 310.

Here, the GRE A-1 361 and the GRE A-2 363 are R6 GRE tunnels. Regarding the GRE A-1 361, a BS R6 GRE tunnel ID is allocated by the BS 330 and an ACR R6 GRE tunnel ID is allocated by the ACR 340. In addition, even regarding the GRE A-2 363, a BS R6 GRE tunnel ID is allocated by the BS 330 and an ACR R6 GRE tunnel ID is allocated by the ACR 340. That is, each R6 GRE tunnel has two tunnel IDs allocated by each of both end nodes. Accordingly, the BS 330 and the ACR 340 manage the R6 GRE tunnels 360 corresponding to the respective service flows of the PSSs 300 and 310, and the R6 GRE tunnel IDs allocated to the R6 GRE tunnels 360. Data transmitted between the BS 330 and the ACR 340 includes the R6 GRE tunnel IDs. At this time, the R6 GRE tunnel IDs included are tunnel IDs allocated by a receiving node. That is, the BS R6 GRE tunnel ID is used at DL transmission, and the ACR R6 GRE tunnel ID is used at UpLink (UL) transmission. Accordingly, in exemplary embodiments of the present invention, a ‘down R6 GRE tunnel ID’ represents the BS R6 GRE tunnel ID, and an ‘up R6 GRE tunnel ID’ represents the ACR R6 GRE tunnel ID.

Moreover, the GRE R-1 351 is an R8 GRE tunnel Regarding the GRE R-1 351, RS R8 GRE tunnel IDs corresponding to the respective service flows 301, 303, and 311 of the PSSs 300 and 310 are allocated by the RS 320, and BS R8 GRE tunnel IDs corresponding to the respective service flows 301, 303, and 311 of the PSSs 300 and 310 are allocated by the BS 330. That is, the R8 GRE tunnel has as many tunnel IDs as 2×[number of service flows of PSSs] allocated by each of both end nodes. Accordingly, the RS 320 and the BS 330 each manage the R8 GRE tunnel IDs for mapping the service flow (FID B-1) 311 of the PSS B 310 to the GRE R-1 351. A signaling message transmitted between the RS 320 and the BS 330 includes the R8 GRE tunnel ID. At this time, the R8 GRE tunnel ID included is a tunnel ID allocated by a receiving node. That is, the RS R8 GRE tunnel ID is used at DL transmission, and the BS R8 GRE tunnel ID is used at UL transmission. Accordingly, in exemplary embodiments of the present invention, a ‘down R8 GRE tunnel ID’ represents the RS R8 GRE tunnel ID, and an ‘up R8 GRE tunnel ID’ represents the BS R8 GRE tunnel ID.

In summary, the BS 330 and the ACR 340 manage an R6 GRE tunnel for each service flow of the PSSs 300 and 310 and R6 GRE tunnel IDs, while the RS 320 and the BS 330 generate one R8 GRE tunnel for respective service flows of the PSSs 300 and 310, and manage each of R8 GRE tunnel IDs mapped to the service flows of the PSSs 300 and 310.

The BS 330 manages mapping information between the R8 GRE tunnel IDs and the R6 GRE tunnel IDs. Accordingly, the BS 330 maps data of the PSSs 300 and 310 received through the R8 GRE tunnel 350, to the R6 GRE tunnel 360 using the mapping information, and maps data of the PSSs 300 and 310 received through the R6 GRE tunnel 360, to the R8 GRE tunnel 350 using the mapping information. For example, if DL data of the PSSs 300 and 310 are received, the BS 330 transmits the DL data to the RS 320 together with the down R8 GRE tunnel ID that corresponds to the down R6 GRE tunnel ID received together with the DL data. Furthermore, if UL data of the PSSs 300 and 310 are received, the BS 330 transmits the UL data to the ACR 340 together with the up R6 GRE tunnel ID that corresponds to the up R8 GRE tunnel ID received together with the UL data.

An example of data forwarding dependent on the relationship between the aforementioned service flows, GRE tunnels, and GRE tunnel IDs is described as follows. If DL data of the PSS A 300 for the service flow (FID A-1) 301 reaches the ACR 340, the ACR 340 forwards the DL data of the PSS A 300 to the BS 330 through the GRE A-1 361. The down R6 GRE tunnel ID allocated to the GRE A-1 361 by the BS 330 is included in a packet including the DL data. And, the BS 330 transmits the DL data to the RS 320 through the GRE R-1 351. The down R8 GRE tunnel ID allocated to the GRE R-1 351 by the RS 320 is included in a packet including the DL data. If receiving the DL data of the PSS A 300 for the service flow (FID A-1) 301 through the GRE R-1 351, the RS 320 determines that the DL data corresponds to the FID A-1 301 through the R8 GRE tunnel ID, and transmits the DL data to the PSS A 300 through the FID A-1 301.

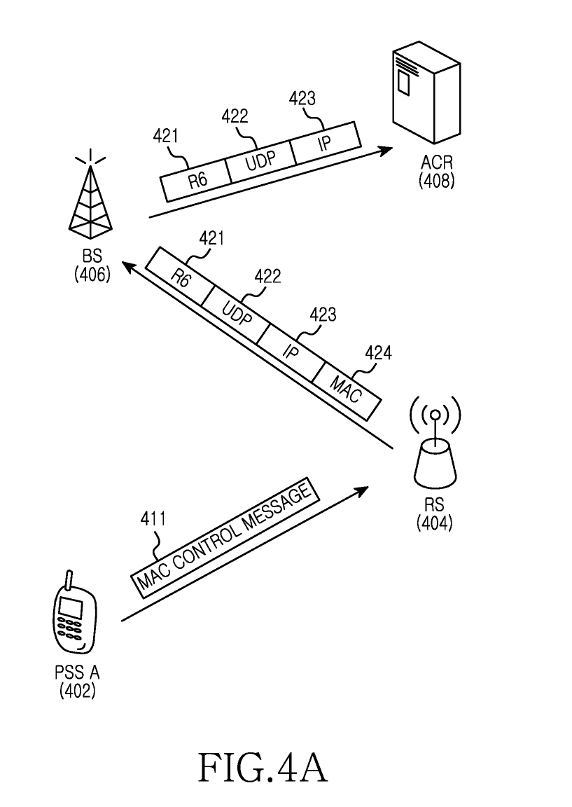

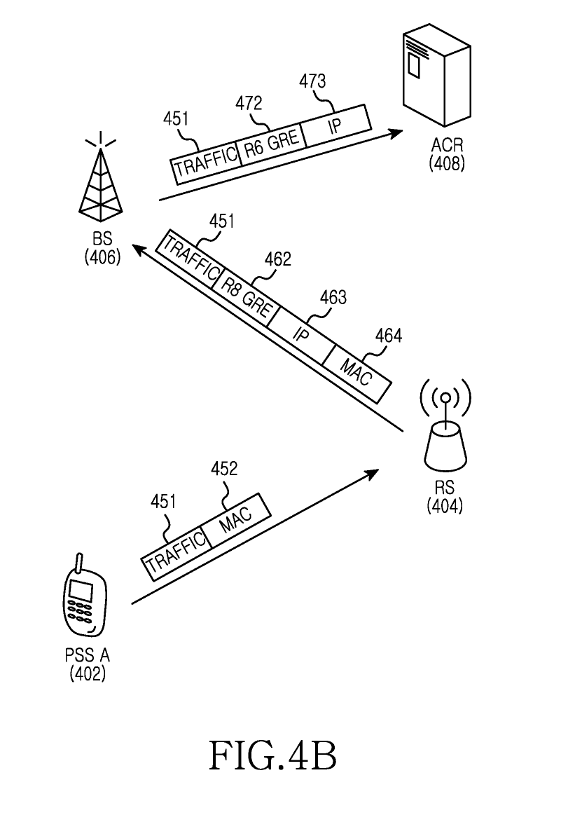

FIGS. 4A and 4B are diagrams illustrating packet structures at multi-hop relay communication in a broadband wireless communication system according to an exemplary embodiment of the present invention.

Referring to FIG. 4A, a packet structure for a MAC control signaling of a PSS is illustrated. A PSS A 402 transmits a MAC control message 411 to an RS 404 through a wireless channel. At this time, the MAC control message 411 is processed in the RS 404 but, in a case where it is signaling needing information exchange with an ACR 408, processing through an R6 signaling message is carried out as follows. For example, the signaling needing the information exchange with the ACR 408 includes handover control signaling. At this time, the RS 404 does not relay the MAC control message 411 to a BS 406, and generates an R6 signaling message 421 for directly processing the MAC control signaling of the PSS A 402 through the MAC control message 411. Moreover, the RS 404 generates an Internet Protocol (IP) packet by attaching a User Datagram Protocol (UDP) header 422 and an IP header 423 to the R6 signaling message 421. Because a link between the RS 404 and the BS 406 is a wireless channel, the RS 404 generates a MAC packet including the IP packet as a payload, by attaching a MAC header 424 to the IP packet, and transmits the MAC packet to the BS 406 through the wireless channel. The BS 406 receiving the MAC packet from the RS 404 relays the IP packet (i.e., the R6 signaling message 421, the UDP header 422, and the IP header 423) that is the payload of the MAC packet to the ACR 408. At this time, it can be appreciated that the BS 406 has to forward the packet to the ACR 408 through destination information included in a header of the R6 signaling message 421. Accordingly, the ACR 408 receives the R6 signaling message 421 corresponding to the MAC control message 411 of the PSS A 402.

Referring to FIG. 4B, a packet structure for forwarding a traffic of a PSS is illustrated. Here, the traffic represents an IP packet. The PSS A 402 transmits a MAC packet including a traffic 451 and a MAC header 452 to the RS 404 through a wireless channel. Next, the RS 404 generates a GRE packet by attaching an R8 GRE header 462 to the traffic 451, and generates an IP packet including the GRE packet as a payload by attaching an IP header 463 to the GRE packet. The R8 GRE header 462 includes an R8 GRE tunnel ID corresponding to a service flow of the PSS A 402. Because a link between the RS 404 and the BS 406 is a wireless channel, the RS 404 generates a MAC packet including the IP packet as a payload by attaching a MAC header 464 to the IP packet, and transmits the MAC packet to the BS 406 through an R8 GRE tunnel established over the wireless channel. The BS 406 receiving the MAC packet from the RS 404 removes the MAC header 464, the IP header 463, and the R8 GRE header 462 from the MAC packet, extracts the traffic 451, and attaches an R6 GRE header 472 to the traffic 451, thereby generating a GRE packet. At this time, the R6 GRE header 472 includes an R6 GRE tunnel ID corresponding to an R8 GRE tunnel ID included in the R8 GRE header 462. Moreover, the BS 406 generates an IP packet by attaching an IP header 473 to the GRE packet and transmits the IP packet to the ACR 408 through an R6 GRE tunnel. Accordingly, the ACR 408 receives the traffic 451 of the PSS A 402.

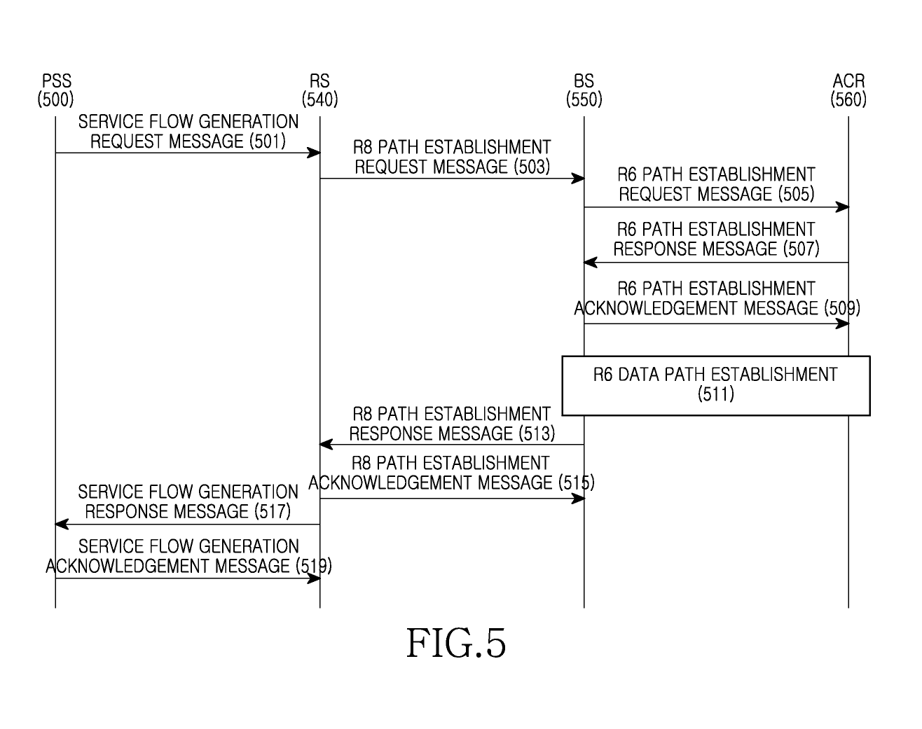

FIG. 5 is a diagram illustrating a signal exchange for a service flow at multi-hop relay communication in a broadband wireless communication system according to an exemplary embodiment of the present invention.

Referring to FIG. 5, in step 501, a PSS 500 transmits a service flow generation request message (DSA-REQ) to an RS 540 to generate a new service flow. The service flow generation request message (DSA-REQ) includes QoS characteristic information of a service flow that the PSS 500 intends to generate, and the like. At this time, although no illustration is given, the RS 540 may transmit a service flow generation reception acknowledgement message (DSA-RCV) to the PSS 500 to inform the PSS 500 of the reception of the service flow generation request message (DSA-REQ).

In step 503, the RS 540 receiving the service flow generation request message (DSA-REQ) transmits an R8 path establishment request message (R8-PATH-REG-REQ) to a BS 550 to inform the BS 550 of a service flow generation request of the PSS 500. The R8 path establishment request message (R8-PATH-REG-REQ) includes quality information of a service flow requested by the PSS 500, a down R8 GRE tunnel ID corresponding to the PSS 500 and allocated to an R8 GRE tunnel by the RS 540, an indicator indicating that it is an R8 path message of a relay system, ID information of a service flow between the RS 540 and the BS 550 mapped to the R8 GRE tunnel ID, and the like.

In step 505, the BS 550 transmits a data path establishment request message (R6-PATH-REG-REQ) to an ACR 560 so as to establish a GRE tunnel for a new service flow of the PSS 500. Here, the data path establishment request message (R6-PATH-REG-REQ) includes service flow request information of the PSS 500, down R6 GRE tunnel ID information allocated to an R6 GRE tunnel corresponding to the service flow by the BS 550, and the like.

In step 507, the ACR 560 receiving the data path establishment request message (R6-PATH-REG-REQ) transmits a data path establishment response message (R6-PATH-REG-RSP) to the BS 550. Here, the data path establishment response message (R6-PATH-REG-RSP) includes ID information on a service flow of the PSS 500, QoS characteristic information of the service flow, up R6 GRE tunnel ID information allocated to the R6 GRE tunnel corresponding to the service flow by the ACR 560, and the like.

Accordingly, in step 509, the BS 550 transmits a data path establishment acknowledgement message (R6-PATH-REG-ACK) to the ACR 560. Thereafter, in step 511, the BS 550 and the ACR 560 establish an R6 path to process data of the PSS 500. At this time, an R6 GRE tunnel ID of the PSS 500 is allocated from each of the BS 550 and the ACR 560. In other words, regarding the R6 GRE tunnel corresponding to the service flow of the PSS 500, a down R6 GRE tunnel ID and an up R6 GRE tunnel ID are allocated.

Here, the data path establishment request message (R6-PATH-REG-REQ) of step 505 is the same as the data path establishment request message (R6-PATH-REG-REQ) of step 203 of FIG. 2. The data path establishment response message (R6-PATH-REG-RSP) of step 507 is the same as the data path establishment response message (R6-PATH-REG-RSP) of step 205 of FIG. 2. The data path establishment acknowledgement message (R6-PATH-REG-ACK) of step 509 is the same as the data path establishment acknowledgement message (R6-PATH-REG-ACK) of step 207 of FIG. 2.

Thereafter, in step 513, the BS 550 transmits an R8 path establishment response message (R8-PATH-REG-RSP) to the RS 540. The R8 path establishment response message (R8-PATH-REG-RSP) informs that an R6 data path and an R8 data path for a service flow requested by the PSS 500 have been established, and includes information of a service flow ID of the PSS 500, an up R8 GRE tunnel ID allocated to a service flow of the PSS 500 by the BS 550, an indicator indicating that it is an R8 path message of a relay system, ID information of a service flow between the RS and the BS mapped to the R8 GRE tunnel ID, and the like.

In step 515, the RS 540 transmits an R8 path establishment acknowledgement message (R8-PATH-REG-ACK) to the BS 550. Thereafter, the RS 540 and the BS 550 manage R8 GRE tunnel IDs each allocated for a service flow of the PSS 500, and the BS 550 and the ACR 560 manage R6 GRE tunnel IDs each allocated for a service flow of the PSS 500. In addition, the BS 550 manages mapping information between the R6 GRE tunnel IDs of the PSS 500 and the R8 GRE tunnel IDs.

In step 517, the RS 540 transmits a service flow generation response message (DSA-RSP) to the PSS 500. The service flow generation response message (DSA-RSP) includes ID information of a service flow requested by the PSS 500, a flow ID for identifying the service flow between the RS 540 and the PSS 500, QoS characteristic information of the service flow, and the like. Accordingly, in step 519, the PSS 500 transmits a service flow generation acknowledgement message (DSA-ACK) to the RS 540.

The signal exchange process of FIG. 5 assumes that the newly generated service flow of the PSS 500 does not affect QoS information of the service flow between the RS 540 and the BS 550. That is, although the QoS information preset between the RS 540 and the BS 550 is maintained, the newly generated service flow of the PSS 500 can be additionally supported. However, in a case where there is a need to change the QoS information set between the RS 540 and the BS 550 because of the newly generated service flow of the PSS 500, in other words, in a case where the newly generated service flow of the PSS 500 cannot be additionally supported by the current QoS information, a QoS information update procedure has to be implemented between the RS 540 and the BS 550. The QoS information update process is as follows.

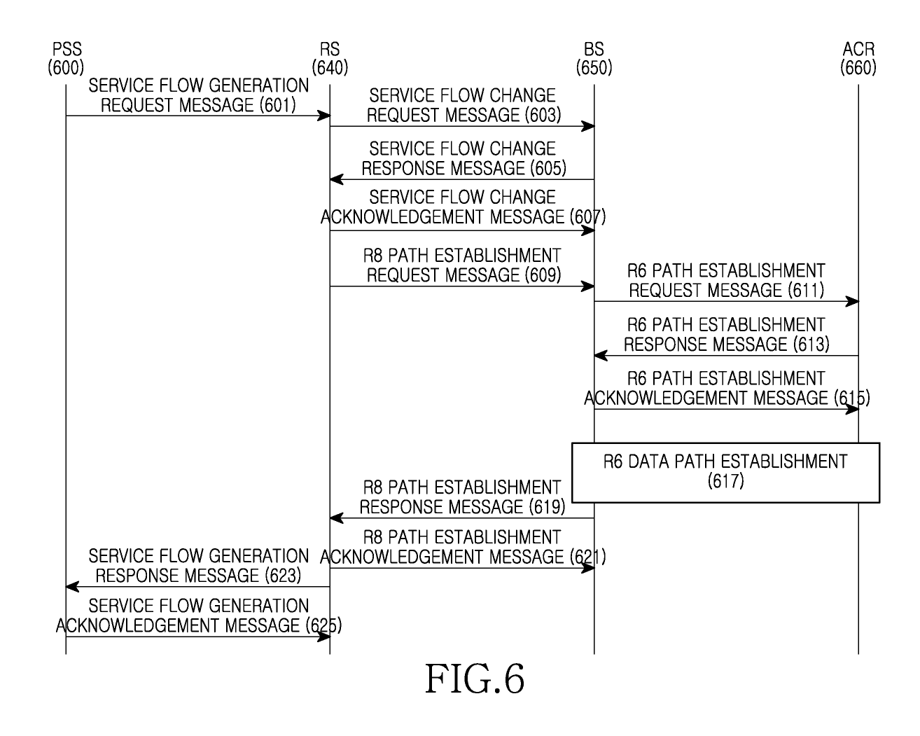

FIG. 6 is a diagram illustrating a signal exchange for QoS update of a service flow between an RS and a BS at multi-hop relay communication in a broadband wireless communication system according to an exemplary embodiment of the present invention.

Referring to FIG. 6, in step 601, a PSS 600 transmits a service flow generation request message (DSA-REQ) to an RS 640 to generate a new service flow. The service flow generation request message (DSA-REQ) includes QoS characteristic information of a service flow that the PSS 600 intends to generate, and the like. At this time, although no illustration is given, the RS 640 may transmit a service flow generation reception acknowledgement message (DSA-RCV) to the PSS 600.

If QoS information of an RS service flow set between the RS 640 and the BS 650 is changed by the new service flow requested by the PSS 600, an RS service flow update procedure is implemented in steps 603 through 607 below.

In step 603, the RS 640 transmits a service flow change request message (DSC-REQ) to the BS 650 for the sake of update of the RS service flow. Here, the service flow change request message (DSC-REQ) includes ID information of a service flow intended for change, QoS information intended for change, and the like.

In step 605, the BS 650 receiving the service flow change request message (DSC-REQ) transmits a service flow change response message (DSC-RSP) to the RS 640. Accordingly, in step 607, the RS 640 transmits a service flow change acknowledgement message (DSC-ACK) to the BS 650 in response to the service flow change response message (DSC-RSP).

Unlike a typical service flow setting/update procedure, the RS service flow update procedure carried out in steps 603 through 607 should not trigger an R6/R8 path establishment procedure. Accordingly, the BS and the RS can previously have setting information having a limit of performing only the RS service flow update procedure, or include an indicator indicating that a service flow generation (DSA) signaling message or a service flow change (DSC) signaling message transmitted/received in the RS service flow update procedure does not trigger the R6/R8 path establishment procedure.

After performing the RS service flow update procedure, the RS 640 and the BS 650 perform an R8 path establishment procedure and an R6 path establishment procedure in steps 609 through 621 below, thereby mapping updated service flow IDs to an R8 GRE tunnel and an R6 GRE tunnel.

In step 609, the RS 640 receiving the service flow generation request message (DSA-REQ) transmits an R8 path establishment request message (R8-PATH-REG-REQ) to the BS 650 to inform the BS 650 of a service flow generation request of the PSS 600. The R8 path establishment request message (R8-PATH-REG-REQ) includes quality information of a service flow requested by the PSS 600, a down R8 GRE tunnel ID corresponding to the PSS 600 and allocated to the R8 GRE tunnel by the RS 640, an indicator indicating that it is an R8 path message of a relay system, an ID of a service flow between the RS 640 and the BS 650 mapped to the R8 GRE tunnel ID, and the like.

Next, in step 611, the BS 650 transmits a data path establishment request message (R6-PATH-REG-REQ) to the ACR 660 so as to establish a GRE tunnel for a new service flow of the PSS 600. Here, the data path establishment request message (R6-PATH-REG-REQ) includes service flow request information of the PSS 600, down R6 GRE tunnel ID information allocated to the R6 GRE tunnel corresponding to the service flow by the BS 650, and the like.

In step 613, the ACR 660 receiving the data path establishment request message (R6-PATH-REG-REQ) transmits a data path establishment response message (R6-PATH-REG-RSP) to the BS 650. Here, the data path establishment response message (R6-PATH-REG-RSP) includes ID information on the service flow of the PSS 600, QoS characteristic information of the service flow, up R6 GRE tunnel ID information allocated to the R6 GRE tunnel corresponding to the service flow by the ACR 660, and the like.

Accordingly, in step 615, the BS 650 transmits a data path establishment acknowledgement message (R6-PATH-REG-ACK) to the ACR 660. Thereafter, in step 617, the BS 650 and the ACR 660 establish an R6 path to process data of the PSS 600. Here, the data path establishment request message (R6-PATH-REG-REQ) of step 611 is the same as the data path establishment request message (R6-PATH-REG-REQ) of step 203 of FIG. 2. The data path establishment response message (R6-PATH-REG-RSP) of step 613 is the same as the data path establishment response message (R6-PATH-REG-RSP) of step 205 of FIG. 2. The data path establishment acknowledgement message (R6-PATH-REG-ACK) of step 615 is the same as the data path establishment acknowledgement message (R6-PATH-REG-ACK) of step 207 of FIG. 2.

Thereafter, in step 619, the BS 650 transmits an R8 path establishment response message (R8-PATH-REG-RSP) to the RS 640. The R8 path establishment response message (R8-PATH-REG-RSP) informs that an R6 data path and an R8 data path for a service flow requested by the PSS 600 have been established, and includes information of a service flow ID of the PSS 600, an up R8 GRE tunnel ID allocated to a service flow of the PSS 600 by the BS 650, an indicator indicating that it is an R8 path message of a relay system, an ID of a service flow between the RS and the BS mapped to the R8 GRE tunnel ID, and the like. In step 621, the RS 640 transmits an R8 path establishment acknowledgement message (R8-PATH-REG-ACK) to the BS 650.

In step 623, the RS 640 transmits a service flow generation response message (DSA-RSP) to the PSS 600. The service flow generation response message (DSA-RSP) includes ID information of a service flow requested by the PSS 600, a flow ID for identifying the service flow between the RS 640 and the PSS 600, QoS characteristic information of the service flow, and the like. Accordingly, in step 625, the PSS 600 transmits a service flow generation acknowledgement message (DSA-ACK) to the RS 640.

Here, the service flow change request message (DSC-REQ), the service flow change response message (DSC-RSP), and the service flow change acknowledgement message (DSC-ACK) that are transmitted/received to perform the service flow update procedure between the RS 640 and the BS 650 can be transmitted as a payload of an L2 transfer message. In addition, the R8 path establishment request message (R8-PATH-REG-REQ), the R8 path establishment response message (R8-PATH-REG-RSP), and the R8 path establishment acknowledgement message (R8-PATH-REG-ACK) for establishing the R8 data path between the RS and the BS can also be transmitted as the payload of the L2 transfer message. The L2 transfer message is a container message for forwarding a MAC signaling message. In a case where the L2 transfer message is used, type information of the L2 transfer message can be set as a relay R6/R8, and a message text of the L2 transfer message can include a message of an R8/R6 message format. The R6/R8 message format begins from a separately defined R6 or R8 message header.

In exemplary embodiments of the present invention of FIGS. 2, 5, and 6, a service flow generation procedure is initiated by a PSS. However, in other exemplary embodiments of the present invention, the service flow generation procedure can be initiated even by a request of a BS or an RS. In addition, a service flow change procedure of FIG. 6 is initiated by the RS. However, in other exemplary embodiments of the present invention, the service flow change procedure can be initiated even by the BS.

An operation procedure and construction of an RS, a BS, and an ACR supporting multi-hop relay communication as above are described below with reference to the accompanying drawings.

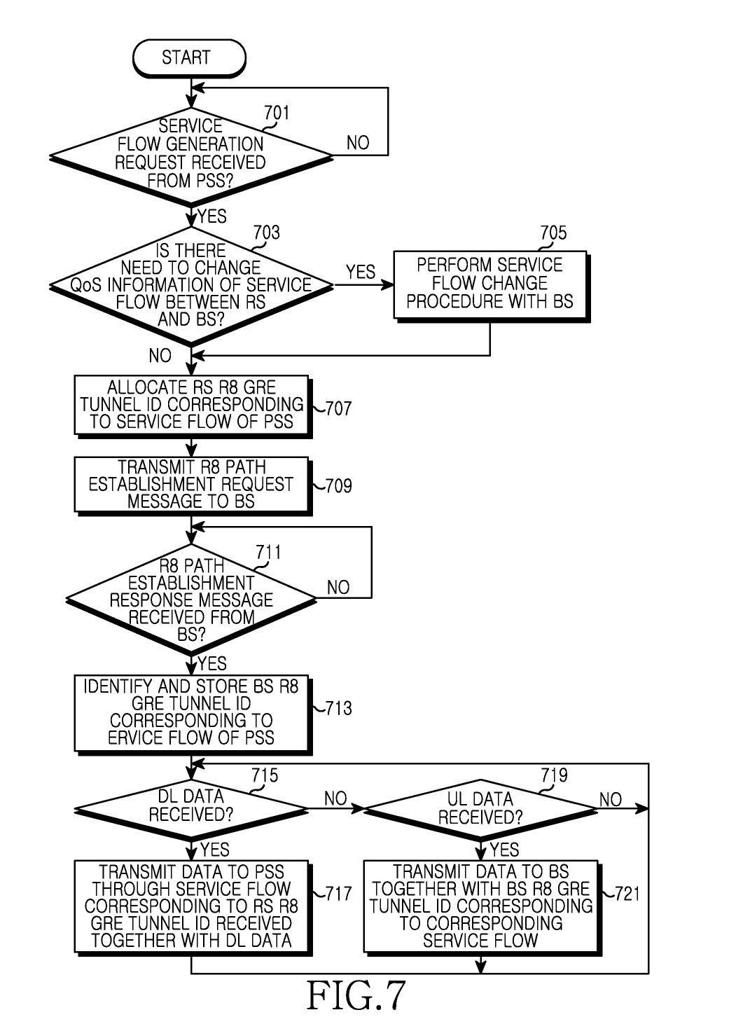

FIG. 7 is a flowchart illustrating an operation procedure of an RS in a broadband wireless communication system according to an exemplary embodiment of the present invention.

Referring to FIG. 7, in step 701, an RS determines if a service flow generation request message (DSA-REQ) is received from a PSS accessing the RS. The service flow generation request message (DSA-REQ) includes QoS characteristic information of a service flow that the PSS intends to generate, and the like.

If it is determined in step 701 that the service flow generation request message (DSA-REQ) is received, the RS determines if there is a need to change QoS information of a service flow between the RS and a BS in step 703. That is, the RS determines if it can additionally support a newly generated service flow of the PSS while maintaining the QoS information of the service flow preset for a link with the BS. If it is determined in step 703 that there is no need to change the QoS information of the service flow, the RS goes to step 707. At this time, although no illustration is given, the RS may transmit a service flow generation reception acknowledgement message (DSA-RCV) to the PSS to inform the PSS of the reception of the service flow generation request message (DSA-REQ).

In contrast, if it is determined in step 703 that there is a need to change the QoS information of the service flow, the RS performs a service flow change procedure with the BS in step 705. That is, the RS transmits/receives a service flow change request message (DSC-REQ), a service flow change response message (DSC-RSP), and a service flow change acknowledgement message (DSC-ACK) with the BS, thereby changing the QoS information of the service flow. Here, unlike a typical service flow setting/update procedure, the service flow update procedure should not trigger an R6/R8 path establishment procedure. Accordingly, the BS and the RS can previously have setting information having a limit of performing only the RS service flow update procedure, or include an indicator indicating that a signaling message transmitted/received in the RS service flow update procedure is a service flow update procedure excluding the R6/R8 path establishment procedure. According to an exemplary embodiment of the present invention, the determination on the change or non-change of the QoS information of the service flow between the BS and the RS can be implemented by the BS. In this case, steps 703 and 705 can be omitted.

In step 707, the RS allocates a down R8 GRE tunnel ID corresponding to a service flow of the PSS. Here, the down R8 GRE tunnel ID denotes an R8 GRE tunnel ID allocated by the RS. An R8 GRE tunnel is a data path carrying data of the PSS between the RS and the BS, and is one irrespective of the number of the service flows of the PSS. The R8 GRE tunnel ID is allocated for every service flow of the PSS and for every allocation subject. In other words, regarding the R8 GRE tunnel, as many R8 GRE tunnel IDs as 2×[number of service flows of PSS] are allocated. That is, step 707 is the step of determining the R8 GRE tunnel IDs corresponding to the service flow of the PSS requested in step 701 and allocated by the RS.

After allocating the down R8 GRE tunnel ID in step 707, the RS transmits an R8 path establishment request message (R8-PATH-REG-REQ) to the BS in step 709. That is, the RS transmits the R8 path establishment request message (R8-PATH-REG-REQ) to the BS requesting that the BS generates an R6 GRE tunnel for the service flow of the PSS. The R8 path establishment request message (R8-PATH-REG-REQ) includes QoS information of a service flow requested in step 701, a down R8 GRE tunnel ID allocated in step 707, an indicator indicating an R8 path message of a relay system, and the like.

Thereafter, the RS determines if an R8 path establishment response message (R8-PATH-REG-RSP) is received from the BS in step 711. The R8 path establishment response message (R8-PATH-REG-RSP) informs that an R6 data path and an R8 data path for the service flow requested in step 701 have been established. The R8 path establishment response message (R8-PATH-REG-RSP) includes information, such as ID information of a service flow requested in step 701, an up R8 GRE tunnel ID allocated to a service flow of the PSS by the BS, an indicator indicating an R8 path message of a relay system, and the like.

If it is determined in step 711 that the R8 path establishment response message (R8-PATH-REG-RSP) is received, the RS identifies and stores the up R8 GRE tunnel ID corresponding to the service flow of the PSS in step 713. That is, because the up R8 GRE tunnel ID is used at relay of UL data of the service flow of the PSS, the RS manages the up R8 GRE tunnel ID as information related to the service flow of the PSS.

The path establishment for the service flow of the PSS is completed in steps 701 through 713. Thereafter, the RS relays the data of the PSS using the above established GRE tunnels and GRE tunnel IDs in steps 715 through 721.

In step 715, the RS determines if DL data of the service flow is received from the BS. If it is determined in step 715 that the DL data is received, the RS transmits the DL data to the PSS through a service flow corresponding to the down R8 GRE tunnel ID received together with the DL data in step 717. In other words, the RS identifies the down R8 GRE tunnel ID in a GRE header of a packet including the DL data received from the BS, generates a MAC packet including the DL data, and transmits the MAC packet through the service flow corresponding to the down R8 GRE tunnel ID.

If it is determined in step 715 that the DL data is not received from the BS, the RS determines if UL data is received from the PSS in step 719. If it is determined in step 719 that the UL data is received, the RS transmits the UL data to the BS together with the up R8 GRE tunnel ID corresponding to the service flow to which the UL data belongs in step 721. In other words, the RS identifies the up R8 GRE tunnel ID corresponding to the service flow, generates a packet including the up R8 GRE tunnel ID and the UL data, and transmits the packet to the BS through an R8 GRE tunnel.

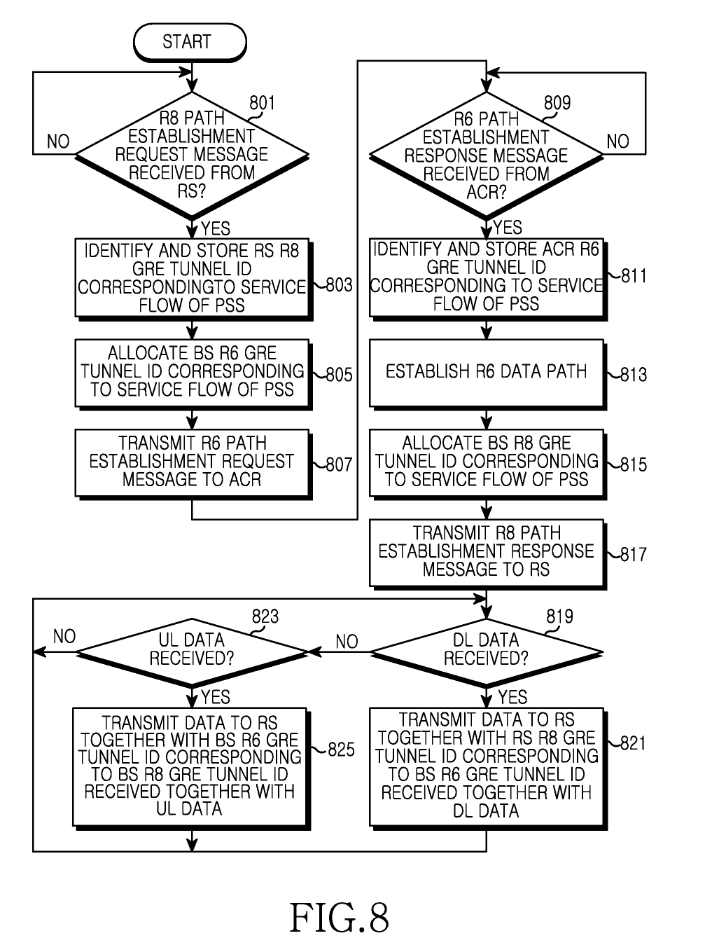

FIG. 8 is a flowchart illustrating an operation procedure of a BS in a broadband wireless communication system according to an exemplary embodiment of the present invention.

Referring to FIG. 8, in step 801, a BS identifies if an R8 path establishment request message (R8-PATH-REG-REQ) is received from an RS. The R8 path establishment request message (R8-PATH-REG-REQ) is a message for the RS to request that the BS generates an R6 GRE tunnel for a service flow of a PSS. The R8 path establishment request message (R8-PATH-REG-REQ) includes QoS information of the service flow of the PSS, a down R8 GRE tunnel ID corresponding to the service flow of the PSS, an indicator indicating an R8 path message of a relay system, and the like.

If it is determined in step 801 that the R8 path establishment request message (R8-PATH-REG-REQ) is received from the RS, the BS identifies the down R8 GRE tunnel ID corresponding to the service flow of the PSS, and stores the ACR R8 GRE tunnel ID in step 803. That is, because the down R8 GRE tunnel ID is used at forwarding of DL data of the service flow of the PSS, the BS manages the down R8 GRE tunnel ID as information related to the service flow of the PSS.

At this time, according to an exemplary embodiment of the present invention, although no illustration is given, the BS can identify QoS information on a newly generated service flow of the PSS through the R8 path establishment request message (R8-PATH-REG-REQ), and determine if it can additionally support the newly generated service flow while maintaining the QoS information of the service flow preset for a link between the RS and the BS. If it is determined that there is a need to change the QoS information of the service flow, the BS can perform a service flow change procedure with the RS. That is, the BS transmits/receives a service flow change request message (DSC-REQ), a service flow change response message (DSC-RSP), and a service flow change acknowledgement message (DSC-ACK), thereby changing the QoS information of the service flow with the RS. Here, unlike a typical service flow setting/update procedure, the service flow update procedure should not trigger an R6/R8 path establishment procedure. Accordingly, the BS and the RS can previously have setting information having a limit of performing only the RS service flow update procedure, or include an indicator indicating that a signaling message transmitted/received in the RS service flow update procedure is a service flow update procedure excluding the R6/R8 path establishment procedure. According to an exemplary embodiment of the present invention, the determination on the change or non-change of the QoS information of the service flow between the BS and the RS can be implemented by the RS.

In step 805, the BS allocates a down R6 GRE tunnel ID corresponding to a service flow of the PSS. Here, the down R6 GRE tunnel ID denotes an R6 GRE tunnel ID allocated by the BS. An R6 GRE tunnel is a data path carrying data of the PSS between the BS and an ACR, and corresponds to the service flow of the PSS on a point-to-point basis. The R6 GRE tunnel ID is allocated for every allocation subject. In other words, regarding the R6 GRE tunnel, two tunnel IDs are allocated. That is, step 805 is the step of determining the R6 GRE tunnel ID allocated by the BS.

After allocating the down R6 GRE tunnel ID in step 805, the BS transmits an R6 path establishment request message (R6-PATH-REG-REQ) to the ACR in step 807. The R6 path establishment request message (R6-PATH-REG-REQ) is a message for requesting establishment of an R6 GRE tunnel for the service flow of the PSS. The R6 path establishment request message (R6-PATH-REG-REQ) includes service flow request information of the PSS, the down R6 GRE tunnel ID allocated in step 805, and the like.

Thereafter, the BS determines if an R6 path establishment response message (R6-PATH-REG-RSP) is received from the ACR in step 809. The R6 path establishment response message (R6-PATH-REG-RSP) includes information, such as ID information of the service flow of the PSS, QoS characteristic information of the service flow, up R6 GRE tunnel ID information allocated by the ACR, and the like.

If it is determined in step 809 that the R6 path establishment response message (R6-PATH-REG-RSP) is received from the ACR, the BS identifies and stores the up R6 GRE tunnel ID corresponding to the service flow of the PSS in step 811. That is, because the up R6 GRE tunnel ID is used at forwarding of UL data of the service flow of the PSS, the BS manages the up R6 GRE tunnel ID as information related to the service flow of the PSS.

In step 813, the BS establishes an R6 data path for the service flow of the PSS with the ACR. At this time, although no illustration is given, the BS can transmit to the ACR an R6 path establishment acknowledgement message of informing that it has received the R6 path establishment response message from the ACR.

In step 815, the BS allocates an up R8 GRE tunnel ID corresponding to the service flow of the PSS. Here, the up R8 GRE tunnel ID denotes an R8 GRE tunnel ID allocated by the BS. An R8 GRE tunnel is a data path carrying data of the PSS between the RS and the BS, and is one irrespective of the number of the service flows of the PSS. The R8 GRE tunnel ID is allocated for every service flow of the PSS and for every allocation subject. In other words, regarding the R8 GRE tunnel, as many R8 GRE tunnel IDs as 2×[number of service flows of PSS] are allocated. That is, step 815 is the step of determining the R8 GRE tunnel IDs corresponding to the service flow of the PSS and allocated by the BS.

After allocating the up R8 GRE tunnel ID in step 815, the BS transmits an R8 path establishment response message (R8-PATH-REG-RSP) to the RS in step 817. The R8 path establishment response message (R8-PATH-REG-RSP) informs that an R6 data path and an R8 data path for the service flow of the PSS have been established. The R8 path establishment response message (R8-PATH-REG-RSP) includes ID information of the service flow of the PSS, an up R8 GRE tunnel ID allocated in step 817, an indicator indicating an R8 path message of a relay system, and the like. Thereafter, although no illustration is given, the BS can receive an R8 path establishment acknowledgement message of informing the reception of the R8 path establishment response message (R8-PATH-REG-RSP), from the RS.

The path establishment for the service flow of the PSS is completed in steps 801 through 817. Thereafter, the BS transmits/receives the data of the PSS using the above established GRE tunnels and GRE tunnel IDs in steps 819 through 825.

In step 819, the BS determines if DL data of the service flow is received from the ACR. The DL data is received through an R6 GRE tunnel corresponding to the service flow, and is a payload of a packet including an IP header and a GRE header. At this time, the GRE header includes a down R6 GRE tunnel ID for the R6 GRE tunnel.

If it is determined in step 819 that the DL data is received from the ACR, the RS transmits the DL data to the RS together with the down R8 GRE tunnel ID corresponding to the down R6 GRE tunnel ID received together with the DL data in step 821. In other words, the BS identifies the down R6 GRE tunnel ID in the GRE header included in the packet received from the ACR, identifies the down R8 GRE tunnel ID corresponding to the down R6 GRE tunnel ID, generates a MAC packet including the DL data, and transmits the MAC packet to the RS through the R8 GRE tunnel.

In contrast, if it is determined in step 819 that the DL data is not received, the RS determines if UL data is received from the RS in step 823. The UL data is received through the R8 GRE tunnel, and is a payload of a packet including a MAC header of the RS, an IP header, and a GRE header. Here, the GRE header includes the down R8 GRE tunnel ID.

If it is determined in step 823 that the UL data is received from the RS, the BS transmits the UL data to the ACR together with the up R6 GRE tunnel ID corresponding to the up R8 GRE tunnel ID received together with the UL data in step 825. In other words, the BS identifies the up R8 GRE tunnel ID in the GRE header included in the packet received from the RS, identifies the up R6 GRE tunnel ID corresponding to the up R8 GRE tunnel ID, generates a packet including the up R6 GRE tunnel ID and the UL data, and transmits the packet to the ACR through the R6 GRE tunnel corresponding to the up R6 GRE tunnel ID.

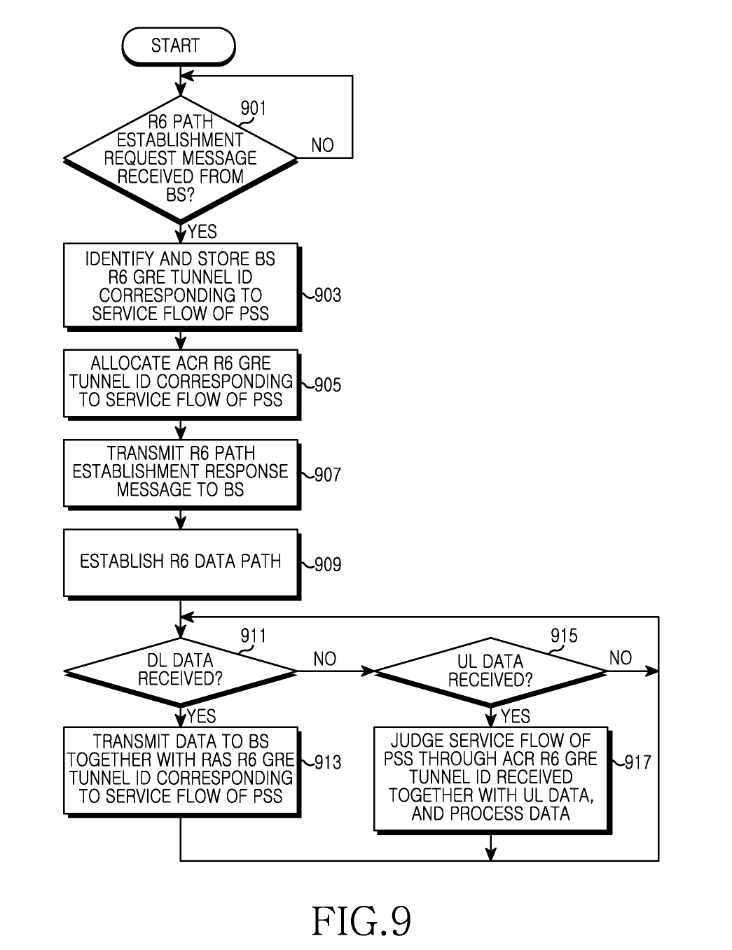

FIG. 9 is a flowchart illustrating an operation procedure of an ACR in a broadband wireless communication system according to an exemplary embodiment of the present invention.

Referring to FIG. 9, in step 901, an ACR determines if an R6 path establishment request message (R6-PATH-REG-REQ) is received from a BS. The R6 path establishment request message (R6-PATH-REG-REQ) is a message for requesting establishment of an R6 GRE tunnel for a service flow of a PSS. The R6 path establishment request message (R6-PATH-REG-REQ) includes service flow request information of the PSS, a down R6 GRE tunnel ID allocated by the BS, and the like.

If it is determined in step 901 that the R6 path establishment request message (R6-PATH-REG-REQ) is received from the BS, the ACR identifies and stores the down R6 GRE tunnel ID corresponding to the service flow of the PSS in step 903. That is, because the down R6 GRE tunnel ID is used at forwarding of DL data of the service flow of the PSS, the ACR manages the down R6 GRE tunnel ID as information related to the service flow of the PSS.

In step 905, the ACR allocates an up R6 GRE tunnel ID corresponding to the service flow of the PSS. Here, the up R6 GRE tunnel ID denotes an R6 GRE tunnel ID allocated by the ACR. An R6 GRE tunnel is a data path carrying data of the PSS between the BS and the ACR, and corresponds to the service flow of the PSS on a point-to-point basis. The R6 GRE tunnel ID is allocated every allocation subject. In other words, regarding the R6 GRE tunnel, two tunnel IDs are allocated. That is, step 905 is the step of determining the R6 GRE tunnel ID allocated by the ACR.

After allocating the up R6 GRE tunnel ID in step 905, the ACR transmits an R6 path establishment response message (R6-PATH-REG-RSP) to the BS in step 907. The R6 path establishment response message (R6-PATH-REG-RSP) includes ID information for the service flow of the PSS, QoS characteristic information of the service flow, an up R6 GRE tunnel ID allocated in step 905, and the like.

In step 909, the ACR establishes an R6 data path for the service flow of the PSS with the BS. At this time, although no illustration is given, the ACR can receive an R6 path establishment acknowledgement message of informing that it has received the R6 path establishment response message, from the BS.

The path establishment for the service flow of the PSS is completed through steps 901 to 909. Thereafter, the ACR transmits/receives the data of the PSS using the above established GRE tunnels and GRE tunnel IDs in steps 911 through 917.

In step 911, the ACR determines if DL data of the service flow of the PSS is received from a core network. The DL data denotes an IP packet whose destination is a PSS. The service flow to which the DL data belongs is determined by a predefined Classification (CS) rule.

If it is determined in step 911 that the DL data is received, the ACR transmits the DL data to the BS together with the down R6 GRE tunnel ID corresponding to the service flow of the PSS in step 913. In other words, the ACR generates a packet including the down R6 GRE tunnel ID and the DL data, and transmits the packet to the BS through the R6 GRE tunnel corresponding to the down R6 GRE tunnel ID.

In contrast, if it is determined in step 911 that the DL data is not received, the ACR determines if UL data is received from the BS in step 915. The UL data is received through the R6 GRE tunnel corresponding to the service flow of the PSS, and is a payload of a packet including an IP header and a GRE header. At this time, the GRE header includes the up R6 GRE tunnel ID for the R6 GRE tunnel.

If it is determined in step 915 that the UL data is received, the ACR determines the service flow of the PSS to which the UL data belongs through the up R6 GRE tunnel ID received together with the UL data, and processes the UL data in step 917. That is, the ACR transmits the UL data to a destination included in the IP header within the UL data through the core network.

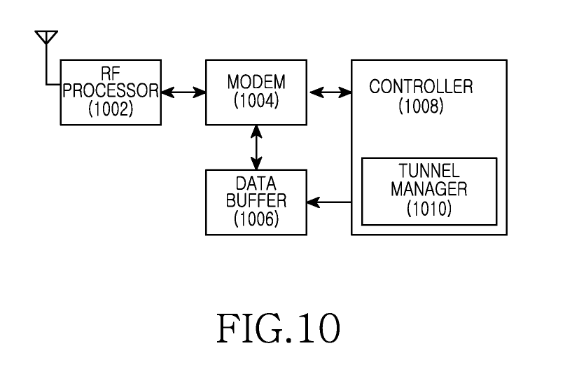

FIG. 10 is a block diagram illustrating a construction of an RS in a broadband wireless communication system according to an exemplary embodiment of the present invention.

Referring to FIG. 10, an RS including a Radio Frequency (RF) processor 1002, a modem 1004, a data buffer 1006, and a controller 1008 is illustrated.

The RF processor 1002 performs a function for transmitting/receiving a signal through a wireless channel, such as signal band conversion, amplification, and the like. That is, the RF processor 1002 up-converts a baseband signal provided from the modem 1004 into an RF band signal and transmits the RF band signal through an antenna, and down-converts an RF band signal received through the antenna into a baseband signal.

The modem 1004 performs a function of conversion between a baseband signal and a bit stream according to a physical layer standard of a system. For example, at data transmission, the modem 1004 generates complex symbols by encoding and modulating a transmission bit stream, maps the complex symbols to subcarriers, and configures OFDM symbols through Inverse Fast Fourier Transform (IFFT) operation and Cyclic Prefix (CP) insertion. In addition, at data reception, the modem 1004 divides a baseband signal provided from the RF processor 1002 in the unit of OFDM symbols, restores signals mapped to subcarriers through Fast Fourier Transform (FFT) operation, and restores a reception bit stream through demodulation and decoding.

The data buffer 1006 temporarily stores received relay data, and outputs the stored relay data to the modem 1004 under the control of the controller 1008. The controller 1008 controls the typical functions of the RS. For example, the controller 1008 generates and analyzes a MAC control message transmitted/received with a PSS accessing the RS, and generates and analyzes an R8 signaling message transmitted/received with a BS. In addition, the controller 1008 processes MAC signaling of a PSS accessing the RS. More particularly, the controller 1008 controls a data path establishment procedure for multi-hop relay communication and a data relay procedure for the multi-hop relay communication. In addition, for the sake of data path establishment for the multi-hop relay communication and data relay for the multi-hop relay communication, the controller 1008 includes a tunnel manager 1010 for managing information on an R8 GRE tunnel between the RS and the BS.

An operation of the controller 1008 for the data path establishment for the multi-hop relay communication is described as follows. If a service flow generation request message (DSA-REQ) is received from a PSS accessing the RS, the controller 1008 determines if there is a need to change QoS information of a service flow between the RS and the BS. If the determination result is that there is a need to change the QoS information of the service flow, the controller 1008 performs a service flow change procedure with the BS. Next, the tunnel manager 1010 allocates a down R8 GRE tunnel ID corresponding to the service flow of the PSS, and the controller 1008 generates and transmits an R8 path establishment request message (R8-PATH-REG-REQ) to the BS through the modem 1004 and the RF processor 1002. Thereafter, if an R8 path establishment response message (R8-PATH-REG-RSP) is received from the BS, the controller 1008 identifies an up R8 GRE tunnel ID corresponding to the service flow of the PSS included in the R8 path establishment response message (R8-PATH-REG-RSP), and the tunnel manager 1010 stores the up R8 GRE tunnel ID.

An operation of the controller 1008 for the data relay through the multi-hop relay communication is described as follows. If DL data of the service flow is received from the BS, the controller 1008 controls the modem 1004 and the RF processor 1002 to transmit the DL data to the PSS through a service flow corresponding to a down R8 GRE tunnel ID received together with the DL data. In other words, the controller 1008 identifies the down R8 GRE tunnel ID in a GRE header of a packet including the DL data received from the BS, generates a MAC packet including the DL data, and transmits the MAC packet through the service flow corresponding to the down R8 GRE tunnel ID. In addition, if the UL data is received, the controller 1008 controls the modem 1004 and the RF processor 1002 to transmit the UL data to the BS together with an up R8 GRE tunnel ID corresponding to a service flow to which the UL data belongs. In other words, the controller 1008 identifies the up R8 GRE tunnel ID corresponding to the service flow, generates a packet including the up R8 GRE tunnel ID and the UL data, and transmits the packet to the BS through an R8 GRE tunnel.

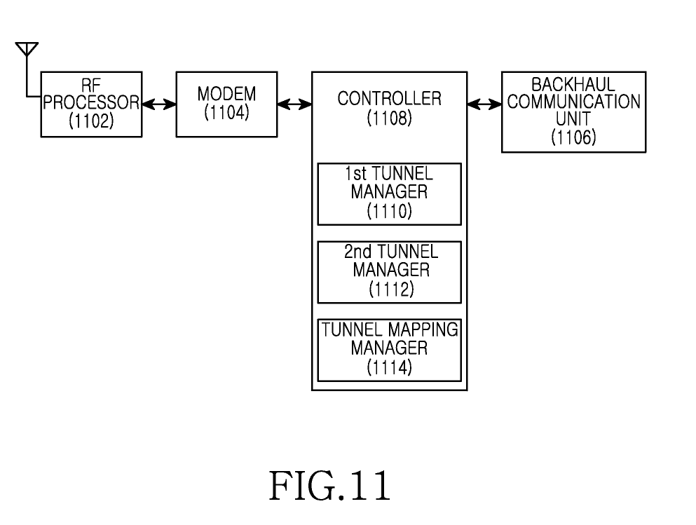

FIG. 11 is a block diagram illustrating a construction of a BS in a broadband wireless communication system according to an exemplary embodiment of the present invention.

Referring to FIG. 11, a BS including an RF processor 1102, a modem 1104, a backhaul communication unit 1106, and a controller 1108 is illustrated.

The RF processor 1102 performs a function for transmitting/receiving a signal through a wireless channel, such as signal band conversion, amplification, and the like. That is, the RF processor 1102 up-converts a baseband signal provided from the modem 1104 into an RF band signal and transmits the RF band signal through an antenna, and down-converts an RF band signal received through the antenna into a baseband signal.

The modem 1104 performs a function of conversion between a baseband signal and a bit stream according to a physical layer standard of a system. For example, at data transmission, the modem 1104 generates complex symbols by encoding and modulating a transmission bit stream, maps the complex symbols to subcarriers, and configures OFDM symbols through IFFT operation and CP insertion. In addition, at data reception, the modem 1104 divides a baseband signal provided from the RF processor 1102 in the unit of OFDM symbols, restores signals mapped to subcarriers through FFT operation, and restores a reception bit stream through demodulation and decoding.

The backhaul communication unit 1106 provides an interface for the BS to perform communication with an ACR. That is, the backhaul communication unit 1106 converts a bit stream transmitted from the BS to the ACR into a physical signal, and converts a physical signal received from the ACR into a bit stream.

The controller 1108 controls the typical functions of the BS. More particularly, the controller 1108 controls a data path establishment procedure for multi-hop relay communication and a data relay procedure for the multi-hop relay communication. In addition, for the sake of data path establishment for the multi-hop relay communication and data relay for the multi-hop relay communication, the controller 1108 includes a first tunnel manager 1110 for managing information on an R8 GRE tunnel between the RS and the BS, a second tunnel manager 1112 for managing information on an R6 GRE tunnel between the BS and the ACR, and a tunnel mapping manager 1114 for managing information on a mapping relationship between the R8 GRE tunnel and the R6 GRE tunnel.

An operation of the controller 1108 for the data path establishment for the multi-hop relay communication is described as follows. If an R8 path establishment request message (R8-PATH-REG-REQ) is received from an RS, the controller 1108 identifies a down R8 GRE tunnel ID corresponding to a service flow of a PSS, and the first tunnel manager 1110 stores the ACR R8 GRE tunnel ID. Next, the controller 1108 allocates a down R6 GRE tunnel ID corresponding to the service flow of the PSS, and the second tunnel manager 1112 stores the down R6 GRE tunnel ID. Thereafter, the controller 1108 generates and transmits an R6 path establishment request message (R6-PATH-REG-REQ) to the ACR through the backhaul communication unit 1106. Next, if an R6 path establishment response message (R6-PATH-REG-RSP) is received from the ACR through the backhaul communication unit 1106, the controller 1108 identifies an up R6 GRE tunnel ID corresponding to the service flow of the PSS, and the second tunnel manager 1112 stores the up R6 GRE tunnel ID. Next, the controller 1108 establishes an R6 data path for a service flow of the PSS with the ACR, and allocates an up R8 GRE tunnel ID corresponding to the service flow of the PSS. Accordingly, the first tunnel manager 1110 stores the up R8 GRE tunnel ID, and the tunnel mapping manager 1114 sets and stores mapping information between R8 GRE tunnel IDs corresponding to the service flow of the PSS and R6 GRE tunnel IDs. Thereafter, the controller 1108 generates an R8 path establishment response message (R8-PATH-REG-RSP), and transmits the R8 path establishment response message (R8-PATH-REG-RSP) to the RS through the modem 1104 and the RF processor 1102.

An operation of the controller 1108 for the data relay through the multi-hop relay communication is described as follows. If DL data is received from the ACR, the controller 1108 controls the modem 1104 and the RF processor 1102 to transmit the DL data to the RS together with a down R8 GRE tunnel ID corresponding to a down R6 GRE tunnel ID received together with the DL data. In other words, the controller 1108 identifies the down R6 GRE tunnel ID in a GRE header included in a packet received from the ACR, identifies a down R8 GRE tunnel ID corresponding to the down R6 GRE tunnel ID, generates a MAC packet including the down R8 GRE tunnel ID and the DL data, and transmits the MAC packet to the RS through an R8 GRE tunnel. In addition, if the UL data is received, the controller 1108 controls the backhaul communication unit 1106 to transmit the UL data to the ACR together with an up R6 GRE tunnel ID corresponding to an up R8 GRE tunnel ID received together with the UL data. In other words, the controller 1108 identifies the up R8 GRE tunnel ID in the GRE header included in the packet received from the RS, identifies the up R6 GRE tunnel ID corresponding to the up R8 GRE tunnel ID, generates a packet including the up R6 GRE tunnel ID and the UL data, and transmits the packet to the ACR through an R6 GRE tunnel corresponding to the up R6 GRE tunnel ID.

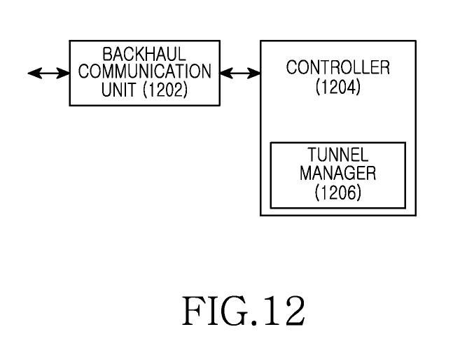

FIG. 12 is a block diagram illustrating a construction of an ACR in a broadband wireless communication system according to an exemplary embodiment of the present invention.

Referring to FIG. 12, a backhaul communication unit 1202 provides an interface for the ACR to perform communication with a BS and a core network. That is, the backhaul communication unit 1202 converts a transmitted bit stream into a physical signal, and converts a received physical signal into a bit stream.

A controller 1204 controls the typical functions of the ACR. More particularly, the controller 1204 controls a data path establishment procedure for multi-hop relay communication and a data relay procedure for the multi-hop relay communication. In addition, for the sake of data path establishment for the multi-hop relay communication and data relay for the multi-hop relay communication, the controller 1204 includes a tunnel manager 1206 for managing information on an R6 GRE tunnel between the BS and the ACR.

An operation of the controller 1204 for the data path establishment for the multi-hop relay communication is described as follows. If an R6 path establishment request message (R6-PATH-REG-REQ) is received from a BS, the controller 1204 identifies a down R6 GRE tunnel ID corresponding to a service flow of a PSS, and the tunnel manager 1206 stores the down R6 GRE tunnel ID. Next, the controller 1204 allocates an up R6 GRE tunnel ID corresponding to the service flow of the PSS, and the tunnel manager 1206 stores the up R6 GRE tunnel ID. And, the controller 1204 generates and transmits an R6 path establishment response message (R6-PATH-REG-RSP) to the BS through the backhaul communication unit 1202. Next, the controller 1204 establishes an R6 data path for a service flow of the PSS with the BS.

An operation of the controller 1204 for the data relay through the multi-hop relay communication is described as follows. If DL data is received from the core network, the controller 1204 controls the backhaul communication unit 1202 to transmit the DL data to the BS together with the down R6 GRE tunnel ID corresponding to the service flow of the PSS. In other words, the controller 1204 generates a packet including the down R6 GRE tunnel ID and the DL data, and transmits the packet to the BS through an R6 GRE tunnel corresponding to the down R6 GRE tunnel ID. In addition, if UL data is received from the BS, the controller 1204 determines the service flow of the PSS to which the UL data belongs through the up R6 GRE tunnel ID received together with the UL data, and processes the UL data. That is, the controller 1204 transmits the UL data to a destination included in an IP header within the UL data, through the core network.

As described above, exemplary embodiments of the present invention can guarantee a QoS of each PSS by establishing data tunnels corresponding to a service flow of a PSS between a BS and an ACR on a point-to-point basis.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An operation method of a Relay Station (RS) in a wireless communication system with multi-hop relay communication, the method comprising:
if generation of a service flow is requested from a Portable Subscriber Station (PSS) accessing the RS, allocating a first downlink IDentifier (ID) corresponding to the service flow to a first tunnel between a Base Station (BS) and the RS;
transmitting the first downlink ID to the BS and requesting the BS to establish a second tunnel between the BS and an Access Control Router (ACR) for the service flow;
receiving a response to the request of establishing the second tunnel and a first uplink ID corresponding to the service flow and allocated to the first tunnel; and
storing the first uplink ID.

2. The method of claim 1, further comprising:
if UpLink (UL) data of the service flow is received from the PSS, transmitting a packet comprising the first uplink ID and the UL data to the BS through the first data tunnel.

3. The method of claim 1, further comprising:
if DownLink (DL) data of the service flow is received from the BS through the first tunnel, identifying the service flow using the first downlink ID received together with the DL data; and
transmitting the DL data to the PSS through the service flow.

4. The method of claim 1, further comprising:
in a case where there is a need to change Quality of Service (QoS) information of a service flow between the BS and the RS upon the service flow generation request from the PSS, performing a service flow change procedure with the BS.

5. The method of claim 1, wherein the first tunnel comprises an R8 Generic Routing Encapsulation (GRE) tunnel linked between the RS and the BS for carrying data of Portable Subscriber Stations (PSSs) connected to the RS, and the second tunnel comprises an R6 GRE tunnel linked between the BS and an Access Control Router (ACR) for carrying data of PS Ss connected to the ACR.

6. An operation method of a Base Station (BS) in a wireless communication system with multi-hop relay communication, the method comprising:
receiving, from a Relay Station (RS), a request for establishment of a second tunnel between the BS and an Access Control Router (ACR) for a service flow of a Portable Subscriber Station (PSS) and a first downlink IDentifier (ID) corresponding to the service flow and allocated to a first tunnel between the RS and the BS;
allocating a second downlink ID corresponding to the service flow to the second tunnel;
transmitting the second tunnel establishment request and the second downlink ID to the ACR;
receiving a response to the second tunnel establishment request and allocating a second uplink ID corresponding to the service flow to the second tunnel;
establishing a data path for the service flow between the ACR and the BS;
allocating a first uplink ID corresponding to the service flow to the first tunnel; and
transmitting the response to the second tunnel establishment request of the RS and the first uplink ID.

7. The method of claim 6, further comprising:
if a packet comprising UpLink (UL) data of the service flow is received from the RS through the first tunnel, identifying the first uplink ID in a header of the packet;
identifying the second uplink ID corresponding to the first uplink ID; and
transmitting a packet comprising the second uplink ID and the UL data to the ACR through the second tunnel.

8. The method of claim 6, further comprising:
if a packet comprising DownLink (DL) data of the service flow is received from the ACR through the second tunnel, identifying the second downlink ID in a header of the packet;
identifying the first downlink ID corresponding to the second downlink ID; and
transmitting a packet comprising the first downlink ID and the DL data to the RS through the first tunnel.

9. The method of claim 6, wherein the first tunnel comprises an R8 Generic Routing Encapsulation (GRE) tunnel linked between the RS and the BS for carrying data of Portable Subscriber Stations (PSSs) connected to the RS, and the second tunnel comprises an R6 GRE tunnel linked between the BS and an Access Control Router (ACR) for carrying data of PSSs connected to the ACR.

10. An operation method of an Access Control Router (ACR) in a wireless communication system with multi-hop relay communication, the method comprising:
receiving, from a Base Station (RS), a request for establishment of a second tunnel between the BS and the ACR for a service flow of a Portable Subscriber Station (PSS) and a second downlink IDentifier (ID) corresponding to the service flow and allocated to the second tunnel;
allocating a second uplink ID to the second tunnel;
transmitting a response to the second tunnel establishment request and the second uplink ID, to the BS; and
establishing the data path for the service flow between the ACR and the BS.

11. The method of claim 10, further comprising:
if DownLink (DL) data of the service flow is received from a core network, transmitting a packet comprising the second downlink ID corresponding to the service flow and the DL data to the BS through the second tunnel.

12. The method of claim 10, further comprising:
if a packet comprising UpLink (UL) data of the service flow is received from the BS, determining a service flow of a PSS to which the UL data belongs using the second uplink ID included in the packet.

13. The method of claim 10, wherein the second tunnel comprises an R6 Generic Routing Encapsulation (GRE) tunnel.

14. A Relay Station (RS) apparatus in a wireless communication system with multi-hop relay communication, the apparatus comprising:
a controller for, if generation of a service flow is requested from a Portable Subscriber Station (PSS) accessing the RS, allocating a first downlink IDentifier (ID) corresponding to the service flow to a first tunnel between a Base Station (BS) and the RS; and
a modem for transmitting the first downlink ID to the BS, for transmitting a message to the BS requesting establishment of a second tunnel between the BS and an Access Control Router (ACR) for the service flow, and for receiving a response to the request of establishing the second tunnel and a first uplink ID corresponding to the service flow and allocated to the first tunnel,
wherein the controller stores the first uplink ID.

15. The apparatus of claim 14, wherein, if UpLink (UL) data of the service flow is received from the PSS, the controller controls to transmit a packet comprising the first uplink ID and the UL data to the BS through the first data tunnel.

16. The apparatus of claim 14, wherein, if DownLink (DL) data of the service flow is received from the BS through the first tunnel, the controller controls to identify the service flow using the first downlink ID received together with the DL data, and transmit the DL data to the PSS through the service flow.

17. The apparatus of claim 14, wherein, in a case where there is a need to change Quality of Service (QoS) information of a service flow between the BS and the RS upon the service flow generation request from the PSS, the controller performs a service flow change procedure with the BS.

18. The apparatus of claim 14, wherein the first tunnel comprises an R8 Generic Routing Encapsulation (GRE) tunnel linked between the RS and the BS for carrying data of Portable Subscriber Stations (PSSs) connected to the RS, and the second tunnel comprises an R6 GRE tunnel linked between the BS and an Access Control Router (ACR) for carrying data of PSSs connected to the ACR.

19. A Base Station (BS) apparatus in a wireless communication system with multi-hop relay communication, the apparatus comprising:
a controller for, if a request for establishment of a second tunnel between the BS and an Access Control Router (ACR) for a service flow of a Portable Subscriber Station (PSS) and a first downlink IDentifier (ID) corresponding to the service flow and allocated to a first tunnel between a Relay Station (RS) and the BS are received from the RS, allocating a second downlink ID corresponding to the service flow to the second tunnel; and
a modem for transmitting the second tunnel establishment request and the second downlink ID to the ACR,
wherein, if a response to the second tunnel establishment request and a second uplink ID corresponding to the service flow allocated to the second tunnel are received, the controller establishes a data path for the service flow between the ACR and the BS, and allocates a first uplink ID corresponding to the service flow to the first tunnel, and
wherein the modem transmits the response to the second tunnel establishment request of the RS and the first uplink ID.

20. The apparatus of claim 19, wherein, if a packet comprising UpLink (UL) data of the service flow is received from the RS through the first tunnel, the controller controls to identify the first uplink ID in a header of the packet, identify the second uplink ID corresponding to the first uplink ID, and transmit a packet comprising the second uplink ID and the UL data to the ACR through the second tunnel.

21. The apparatus of claim 19, wherein, if a packet comprising DownLink (DL) data of the service flow is received from the ACR through the second tunnel, the controller controls to identify the second downlink ID in a header of the packet, identify the first downlink ID corresponding to the second downlink ID, and transmit a packet comprising the first downlink ID and the DL data to the RS through the first tunnel.

22. The apparatus of claim 19, wherein the first tunnel comprises an R8 Generic Routing Encapsulation (GRE) tunnel linked between the RS and the BS for carrying data of Portable Subscriber Stations (PSSs) connected to the RS, and the second tunnel comprises an R6 GRE tunnel linked between the BS and an Access Control Router (ACR) for carrying data of PSSs connected to the ACR.

23. An access Control Router (ACR) apparatus in a wireless communication system with multi-hop relay communication, the apparatus comprising:
a controller for, if a request for establishment of a second tunnel between a Base Station (BS) and the ACR for a service flow of a Portable Subscriber Station (PSS) and a second downlink IDentifier (ID) corresponding to the service flow and allocated to the second tunnel are received from the BS, allocating a second uplink ID to the second tunnel; and
a modem for transmitting a response to the second tunnel establishment request and the second uplink ID, to the BS,
wherein the controller establishes the data path for the service flow between the ACR and the BS.

24. The apparatus of claim 23, wherein, if DownLink (DL) data of the service flow is received from a core network, the controller controls to transmit a packet comprising the second downlink ID corresponding to the service flow and the DL data to the BS through the second tunnel.

25. The apparatus of claim 23, wherein, if a packet comprising UpLink (UL) data of the service flow is received from the BS, the controller determines a service flow of a PSS to which the UL data belongs using the second uplink ID included in the packet.

26. The apparatus of claim 23, wherein the second tunnel comprises an R6 Generic Routing Encapsulation (GRE) tunnel.
